(19) United States
(12) Patent Application Publication
(10) Pub. No.: US 2002/0097853 A1
(43) Pub. Date: Jul. 25, 2002

(54) Telebudgeter -a multi-task telephone system designed to optimize long distance calls

(76) Inventors: Mohame Ouijdani, Bothell, WA (US); Heinz-Gunter Manfred Zieber, Kirkland, WA (US)

Correspondence Address: Mohamed Ouijdani, 17616 Valley Circle Dr., Bothell, WA, 98012, US

(21) Appl. No.: 09/988,913

(22) Filed: Nov. 20, 2001

Related U.S. Application Data
(60) Provisional application No. 60/249,834, filed on Nov. 20, 2000.

(51) Int. Cl. H04M 15/00

(52) U.S. Cl. 379/114.02

(57) ABSTRACT

The telebudgeter, a multi task telephone system, described herein contains an embedded dynamic least cost routing algorithm and an advanced updating mechanism. This multi task system represents a robust hardware and software design. The hardware design consist of a single chip microcontroller capable of implementing various basic and advanced telephony features while driving a number of peripherals such as LCD displays and transceivers. This multi task telephone system further includes an advanced algorithm to optimize long distance calls using linear digital filters. The system further comprises of a method to automatically purchase pre-paid services from a remote server using advanced encryption algorithms and update look up tables from a remote server over the public telephone network to which the system is connected. The system further includes a budgeting and auditing function that can be accessed locally or on the server via a secured website.

This application claims the benefit of U.S. provisional application No. 60/249,834 filed on Nov. 20, 2000.

### CROSS-REFERENCE TO RELATED APPLICATIONS

| | | |
|---|---|---|
| U.S. Pat. No. 5,881,139 | 6/1999 | Romines |
| U.S. Pat. No. 6,078,652 | | Barak |
| U.S. Pat. No. 4,791,665 | | Bogart et al |
| 4751728 | Jun., 1998 | Treat |
| 4813065 | Mar., 1989 | Segala |
| 5400395 | Mar., 1995 | Berenato |
| 5638433 | Jun., 1997 | Bubien, Jr. et al |

### BACKGROUND OF THE INVENTION

With the deregulation of telecommunications in the US, there has surfaced a large number of new providers of long distance telephone services. Each provider of long distance service is identified by a Carrier Interchange Code (CIC) or a toll-free dial-around-number (DAN). These companies are also known as long distance carriers or long distance providers. These providers entered the telecommunications market to compete with prominent long distance providers. Due to the size of this market, competition has become fierce, thereby causing providers to create several pricing strategies to capture and maintain a market niche. With this changing multiplicity in pricing, the consumer has become confused and can no longer make cost effective decisions due to the multitude of rate plan structures. Examples of the available plan structures include: 1) a per minute rate with 6 second billing intervals, 2) per minute rates with 1 minute billing intervals, 3) per minute rates and minimum monthly bill, 4) per minute rates and monthly membership fees, and 5) a flat fee for a preset length of call plus a per minute rate, among others.

To deal with some of the rate issues, several companies have designed or built independent electronic boxes with built-in least cost routers to help consumers cope with this problem and make the selections automatic. Such boxes, available in the market today, hook up as a telephone peripheral and are very expensive for the average consumer.

In addition to the complex rate plans, most carriers have limited bandwidth capacity. As a result, calls routed via these carriers often are not successful. The inability to complete a call can be of tremendous frustration to the customer. This phenomenon usually happens during business hours and during holidays when the need to speak to one's business colleagues, or family or loved ones is of most importance.

### PRIOR ART

The following summary of prior art discusses the current challenges and attempts to remedy problems associated with multiple rate structures. The multiplicity of rates and methods for updating rate tables is discussed in U.S. Pat. No. 5,881,139 to Romines, Gregory, U.S. Pat. No. 6,078,652 to Barak, Gideon, and U.S. Pat. No. 4,791,665 to Bogart et al. All the prior art also has discussed the main variables in the rate structures of the majority of the carriers, such as the time of day, holidays, weekend, call destination, and applicable discounts to the calls being made.

U.S. Pat. No. 5,881,139 to Romines, Gregory describes a method for capturing a dialed number and comparing it to an internal rate table consisting of the time of the call, carrier codes, and per minute rates. The system then selects the lowest rate carrier, adds its code as a prefix, and redials the full string. This system which consists of a re-dialer box in series with a telephone is also equipped with a means to update the database maintained at a remote location. The update mechanism is automated and initiated by the re-dialer box periodically to receive updates. In addition to the re-dialer being an external box in series with a regular telephone, the re-dialer in this art addresses all calls in a uniform fashion based strictly on dollar per minute cost.

U.S. Pat. No. 6,078,652 to Barak, Gideon describes a least cost routing device and method for placing long distance calls using the lowest price carrier selected from a stored database. In addition to the per minute rate information, the time and destination of calls, and volume call discount information, this device uses a statistical method using historical information to forecast the expected length of a call and routes the call via the expected lowest carrier. This method is designed, for example, to take advantage of rate structures that require a well defined length of usage for the consumer to get a discounted price per call. While this method addresses the expected length of call, it does not address the issue of minimum monthly charges, subscription charges, and the billing increments associated with selected plans. Given the competitive nature of the telecommunication business and the available plans, the rate variations are very small and a few encounters with an answering machine, for a low volume user, may in fact prove costly. In addition, in this scenario, if rate plans contain monthly charges or any type of other monthly fees, the method will result in higher monthly bills as those charges are not amortized.

U.S. Pat. No. 4,791,665 to Bogart et al refers to a PBX telephone system that selects a least cost carrier from a list of carriers. The system includes a database containing access code data associated with the carrier, user authorization, and information about various billing rates based on time of day and destination. The PBX queries the database, finds the lowest cost carrier and routes the call accordingly.

Prior art has not addressed other major issues pertaining to mandatory minimum monthly fees, variations in billing intervals (i.e., 6-second and 1-minute interval billing), bandwidth deficiencies, and user choice. In addition, no prior art that combines a least cost routing system and a budgeting function has been identified.

No prior art was found regarding the benefits of this invention, consisting of the budgeting function, the re-route function in case of bandwidth deficiencies, and the method of conveniently purchasing and using pre-paid services such as phone cards.

### SUMMARY OF THE INVENTION

It is an object of the present invention to overcome the disadvantages of the prior art and provide a feasible, cost effective solution to making long distance phone calls. More specifically, it is an object of this invention to provide the user with a single, easy-to-use telephone system that will eliminate the use of any peripheral, and place all long distance calls through the lowest cost long distance carrier available. The invention will provide the user with an override function to allow him/her to by-pass the selected carrier and use the default carrier. The invention will also effectively amortize any minimum monthly and per call charges as well as solve the bandwidth deficiency by automatically selecting an alternative provider. Moreover, this invention will give the user the opportunity to utilize pre-paid services, such as phone cards and internet telephony services available via dial-around access numbers, and operate within a set budget. All the above is conducted in a seamless and convenient process as described in this art.

This invention is a multi-task telephone system that saves the consumer time and money. These savings are achieved by using one or more of the following methods. The first is a method of selecting the lowest cost carrier for long distance calls. The second is a method to conveniently re-route calls via a secondary carrier when the first carrier cannot complete the call due to bandwidth deficiency or other causes. The third is a method to limit monthly spending on phone bills for users with a limited budget.

### BRIEF DESCRIPTION OF THE SEVERAL VIEWS OF THE DRAWING

FIG. 1. Block diagram showing the relation of the Telebudgeter to the server and to the local exchange.

FIG. 2. Shows a block diagram of the relation among several Telebudgeter units in a PBX environment, the server and the local exchange.

FIG. 3. Flow chart of the least cost routing function

### DETAILED DESCRIPTION OF THE INVENTION

The preferred embodiment according to the invention describes an apparatus herein known as Telebudgeter 10. To further understand the Telebudgeter 10 basic mechanism and methods to accomplish the objects according to the preferred embodiment, each task of the invention can be seen as a separate module within the preferred embodiment and described independently.

Telebudgeter

The Telebudgeter 10 according to the preferred embodiment consists of a means of input 12, such as a keypad, touch screen, voice recognition, or other methods of intercepting input signals; an LCD display 18, a Central Processing Unit CPU 14 such as a microprocessor, a microcontroller or a specialized Digital Signal Processor DSP, and a Local Storage LS 16, and a line interface circuit 20. In the preferred embodiment, the CPU 14 consisting of a microcontroller device, in addition to its primary role of data processing and managing flow of events, is programmed to implement a soft modem function, all the basic telephony requirements such as tone generation and detection, caller id, call waiting, a variety of decompression tasks, an interface with other components such as key-pad, transceivers, LCD controllers, memory storage for data and voice. It is also possible to have an external modem to the microcontroller 14 dedicated to the communication function and for ease of compatibility with off the shelf modems to be installed on the server 24.

Updating the System

The method of updating the information in the Local Storage LS 16 is done via a remote server 24. The system is designed such that either the client 10 or the server 24 can initiate the communication based on preset criteria established during the initialization of the system. The update routine is done periodically to download rate tables and targeted advertisement for such services as pre-paid cards and other consumer related products, and upload to the server 24 the usage information. The update routine is designed to minimize the amount of information transferred using data compression protocols. The data uploaded to the client originates from a local, regional, or national servers.

The type of information loaded into the client consists of but is not limited to:

1. Provider table: the rate table contains a carrier identifier code—CIC—or a dial-around-number—DAN—and carrier name, billing increment 1 minute, 6 seconds or other, applicable minimum monthly fee, and time of day and day of week when rate is applicable, and type of service as in DAN or pre-paid.

2. Domestic table: The domestic table will contain information such as domestic rates including inter and intra-state rates for each of the carriers identified in the provider table.

3. International table: This table will consist of international country codes and applicable rates per provider identified in the provider table.

4. Special code table: This table will consist of special country codes not requiring the international prefix 011 but have higher rates than US intra-state rates and applicable rates. An example of such entries would be Jamaica, Hawaii, Puerto-Rico and other islands using US infrastructure.

5. Broadcast table: This table contains information about other available pre-paid services such as, but not limited to, pre-paid phone cards.

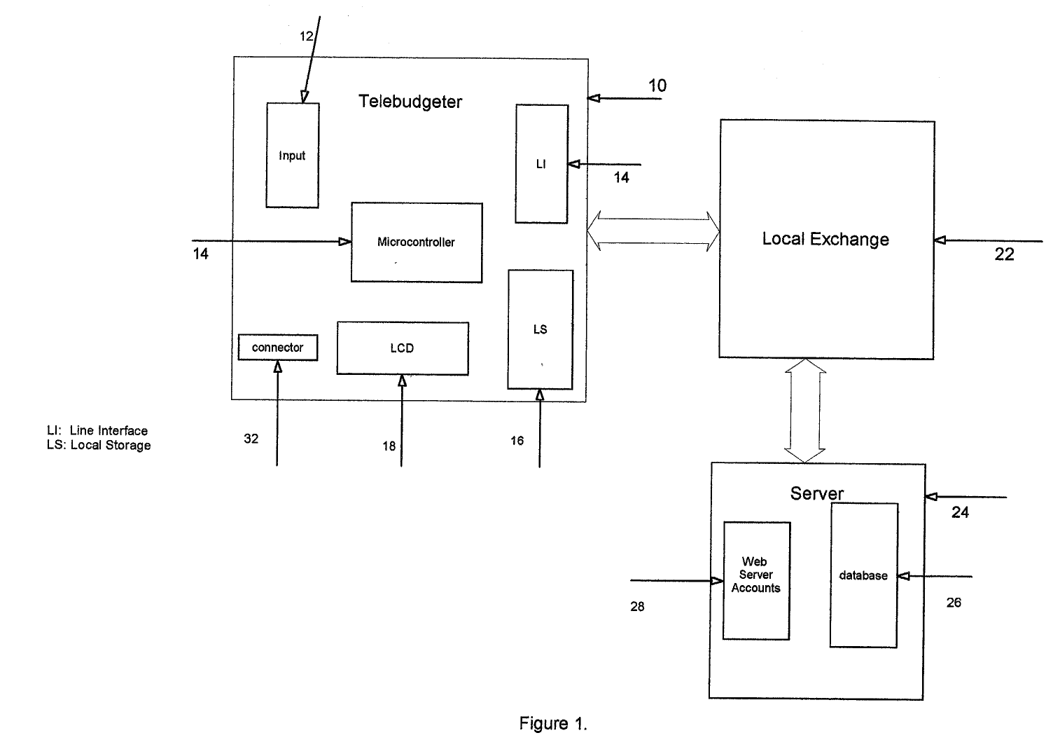

FIG. 1 of the embodiment shows a block diagram of the updating function of the Telebudgeter 10. The diagram shows a single Telebudgeter 10 connected to a local Exchange 22 via a phone line and a Remote server 24 containing all pertinent data such as rate tables, Web accounts, billing system and local pages tables. All the tables are stored in a database 26 inside the server 24. On a given schedule or as needed, remote server 24 dials Telebudgeter 10 to download updated data such as rate tables described above. Remote server 24 is equipped with a transmitter compatible with the receiver installed in Telebudgeter 10 or a conventional modem for the purpose of transferring data. Data transferred is compressed and encrypted for transport and storing in non volatile memory using various compression and encryption schemes to minimize transfer time. Telebudgeter 10 is equipped with a ring detection mechanism that differentiates between data calls and voice calls. Upon detecting a data call Telebudgeter 10 disables the audible ringer and receives data.

Telebudgeter 10 is also equipped with a transmitter in the form of a soft modem and a USART or a regular modem to upload data to remote server 24. Data transferred consists of log of phone calls, log of accessed services, and authentication codes, and other business pertinent information. Remote server 24 is equipped with a compatible receiver or a modem to ensure correct data transfer. Both transmitters and receivers in telebudgeter 10 and remote server 24 can be simple existing off the shelf modems or custom designed soft modems in the microcontroller 14.

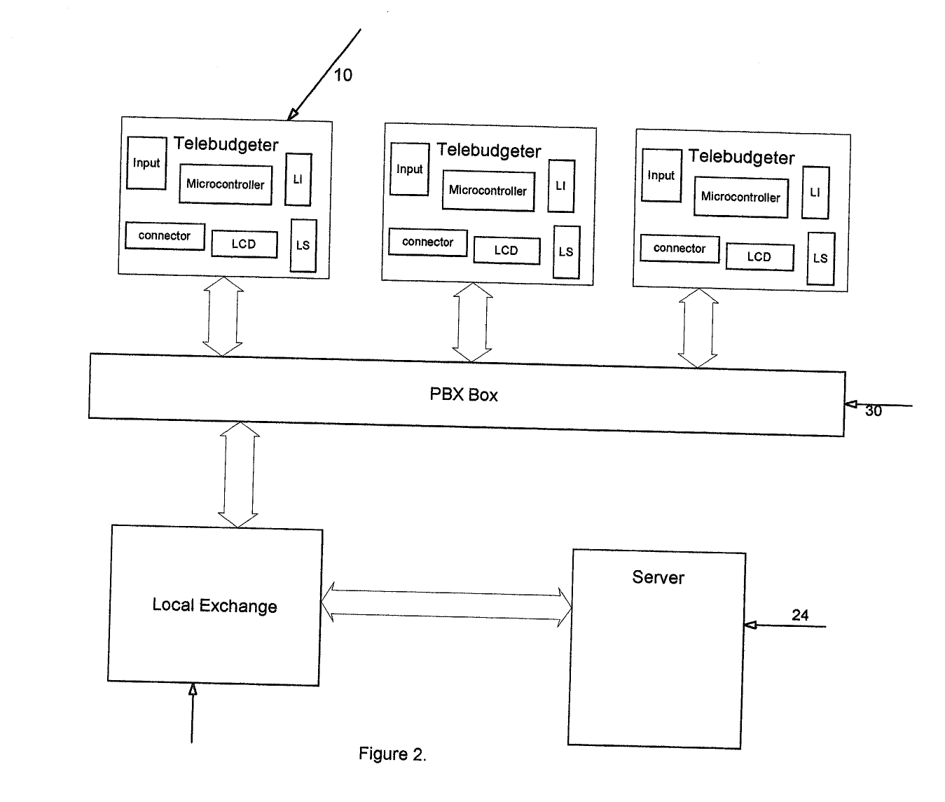

FIG. 2 of the embodiment is a block diagram showing the relation of multiple Telebudgeters 10 to the remote server 24, the local exchange 22, and a PBX box 30. In this figure, when one of the Telebudgeters 10 receives its update from the remote server 24, that telebudgeter 10 updates the other Telebudgeters 10 in the network by dialing their respective extensions.

Updating Pre-paid Service

The pre-paid services update according to the preferred embodiment will prompt the user to make an update or purchase the service from a website or automatically from the telebudgeter 10. To purchase a pre-paid card from the telebudgeter 10, the user will access a preset menu displayed on the LCD display 18 to initiate an automated request to server 24. Server 24 will authenticate the call and assign a new pre-paid account or increase balance on existing one. The server 24 then updates the LCR tables and immediately download such tables to Telebudgeter 10. The Telebudgeter 10 is now ready to include the pre-paid service among the preferred providers. To purchase from a website, the user will access a secured website and follow directions to complete the transaction. Once completed, the rate tables are updated and downloaded to Telebudgeter 10 for immediate use.

Least Cost Router

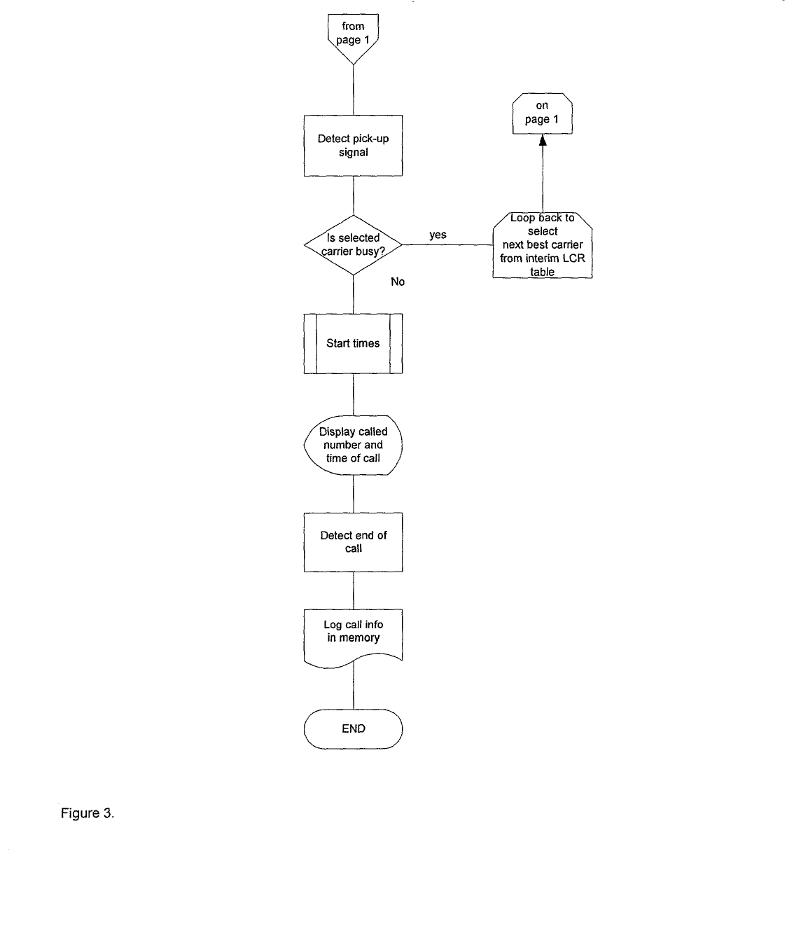

According to the preferred embodiment of the invention as illustrated in FIG. 3, upon placing a call by the user, the Telebudgeter 10 saves input in a buffer that clears itself on on-hook status. The state machine receives the input and parses incoming digits entered by the user. The state machine algorithm embedded in microcontroller 14 continuously analyzes the input. The state machine simply emits the input string to the dialer for a direct dial including emergency calls such as 911. If the state machine compares the incoming digits to table stored prefix values to determine if the call is domestic or international. If the prefix is international, the country code is parsed and a reference to an applicable rate table is generated. For domestic calls, the area code is parsed to determine toll free, dial around, intra or inter state, or special destination. If the call is not toll free call or a local call, the time of day is used to select peak or off peak time estimates and the digit parsing state machine has generated the type of call that is being made. Given those categories, current estimates for the given category can be looked up. When a call has been completed, the duration of that call is used to update the estimates for the call's category.

To generate usage projections, the system implements IIR filters; those familiar with the art should appreciate the use of such filters to achieve optimum estimates within specified parameters. The first filter uses the call attributes to estimate the call length. To actualize the filter, calls exceeding certain threshold limit are truncated to a given maximum length. This is done to keep single events from skewing the estimates. After the call length has been truncated, it is used as an index into a look up table, and that looked up value is then passed into the filter. In updating the filter, a new estimate is generated and stored so that it is available for the next cost calculation.

The second filter, also referred to as a per day filter, is a low pass filter that estimates the daily number of minutes spent for a given a category of toll calls. As part of the provider selection and post call data gathering, the number of minutes spent for each category of calls is accumulated. At midnight this data, if applicable, is applied. This low pass filter has sufficiently long settling time to allow projections of toll call use over a period of one calendar month. A measure of variation is computed and filtered with the same filter parameters of the daily use filter.

The filters output discussed above are used to ensure optimal amortization of the call fees and monthly charges where applicable. All the filter coefficients, and thus the filter bandwidth, as well as look up tables can be changed at the server level 24 as needed and transmitted to each independent telebudgeter 10. The filter coefficients and look up table entries will optimally tune each telebudgeter 10 to best suite the call pattern in which it is used.

Based on the filter criteria and the amortization calculations, carriers will be added and deleted from the interim LCR table and assigned a preferred status. Among the preferred providers, the provider with the greatest amortization shortfall is selected unless the expected call cost is the dominating term. That way, providers are amortized at approximately even rate.

Providers with minimum monthly billing will only be selected if past call patterns indicate that sufficient volume will be created to reasonably expect that the minimum billing will be reached. If one of the preferred providers has a minimum monthly billing that has not yet been amortized, a second provider that also has minimum monthly billing will only be selected and become preferred, if past call patterns suggest sufficiently high volume to reach both minima.

Once a carrier is selected, the Carrier's Interchange Code (CIC) or dial-around-number (DAN) and any other authorization code is added as a prefix to the input number stored in buffer, the call is emitted, and call parameters are displayed on LCD 18. Once the call is transmitted, system listens for pick-up. If system detects busy signal tone in the form of all circuits are busy, system proceeds to recover the number and loop back to select a new carrier from the LCR interim table. If the system detects a pick-up as in voice or data communication, a timer is initiated to record start of call and remains on until end of call to record end of communication. The call is then logged in the call log and stored in local storage LS 16.

The method according to the invention ensures that all calls are routed in the most efficient and cost effective manner for any given call at any given time. The method further ensures that all calls are routed through the lowest carriers with available bandwidth to ensure a reduced level of frustration with resellers' limited bandwidth.

Call Metering

The metering function is designed to track the length of each call initiated by the Telebudgeter. Once the system detects a pick-up signal on the other side of the line, a timer is triggered to count the time elapsed while the user is in communication. Once the communication is completed, the timer stops and the total length of the call is registered. The data is then immediately used to compute the total cost of the transaction using the rate of the selected carrier listed in the rate table stored internally. The information is then logged into the log for later retrieval and for use by the user or the system. The log information is then transferred to a server at a remote location periodically and formatted for user access from a secured web site. Upon purchase of a telebudgeter 10, each user will be provided with a secured account on the central web server that will collect the information from the telebudgeter 10 and make it available for the user to view and analyze.

This function will also track the usage in any given cycle to ensure that a user set budget is not exceeded without the user's override. The metering function will also inform the user when a pre-paid card or service is approaching expiration and recommends additional minutes be purchased.

1. A dynamic multi task telephone system comprising of
a. a least cost routing mechanism to select lowest carrier from plurality of carriers and amortize all call charges and monthly chargers;
b. a method to update data in system from a remote server
c. a method to acquire and utilize pre-paid services such as pre-paid calling cards;
d. a method to set a budget to limit monthly phone bills;

2. A dynamic multi task telephone system described above in claim 1 herein whereby the least cost routing mechanism comprises of:
a. Method for parsing dialed numbers and look up destination of call in look up tables;
b. Real time clock to determine start and end of call as well as time of day and day week
c. A method to calculate numerical projections using a combination of linear digital filters and look up tables;
d. A method to calculate such projections using filter coefficients downloaded from a remote server;
e. A method for above least cost routing calculations ensuring amortization of monthly fees, per call fees, and monthly charges;
f. A method to select alternate providers when preferred selected carrier has a busy signal or noisy signal in previous attempt;
g. A method to override selected selection where user prefers to use default carrier.

3. A dynamic multi task telephone system described in claim 1 above wherein the updating method comprises of:
a. A remote server to download updated rate tables;
b. Means of generating web account on remote server upon system initialization and authentication;
c. Means of transferring other personal data to the multi task telephone system from personal website;

4. A dynamic multi task telephone system described herein in claim 1 above wherein the method of acquiring pre-paid services or pre-paid phone cards consists of:
a. A display to show selections
b. Means to select and access data displayed using input devices as keypad, touch screen, or other means of input devices;
c. A storage for storing selection;
d. Means to automatically connect to server upon initiation from user to purchase a pre-paid service as in pre-paid phone card;

5. A dynamic multi task described herein in claim 1 whereby a budget and or limit on pre-paid card usage is set
a. Means to set a budget from an input screen
b. Means to compare call logs cost to set budget
c. Means to display limit on pre-paid accounts on LCD
d. Means to track pre-paid account charges
